(19) United States
(12) Patent Application Publication
(10) Pub. No.: US 2026/0080643 A1
(43) Pub. Date: Mar. 19, 2026

(54) TEXT-BASED REFERENCE IMAGE GENERATION

(71) Applicant: Adobe Inc., San Jose, CA (US)

(72) Inventors: Cuong D. Nguyen, San Francisco, CA (US); Vladimir Kim, Seattle, WA (US); Thibault Groueix, San Francisco, CA (US); Chen Chen, San Diego, CA (US)

(73) Assignee: Adobe Inc., San Jose, CA (US)

(21) Appl. No.: 18/888,332

(22) Filed: Sep. 18, 2024

(51) Int. Cl. G06T 19/20; G06F 40/30; G06T 5/77; G06T 7/11; G06T 7/13; G06T 7/50; G06T 15/20

(52) U.S. Cl. CPC G06T 19/20; G06F 40/30; G06T 5/77; G06T 7/11; G06T 7/13; G06T 7/50; G06T 15/20; G06T 2200/24; G06T 2207/20084; G06T 2207/20104; G06T 2210/12

(57) ABSTRACT

Techniques for text-based reference image generation are described that support generation of reference digital images of a three-dimensional representation of a digital environment. In an example, a processing device receives a text-based input that describes a feature of a three-dimensional representation of a digital environment. The processing device generates a reference digital image for output that depicts a view of the feature based on a perceptual similarity between the reference digital image and semantic properties of the text-based input. The processing device is further operable to apply one or more edits to the reference digital image based on features of the digital environment as well as on additional user inputs.

### BACKGROUND

Three-dimensional modeling applications are often used to create and manipulate three-dimensional objects in a digital environment. For instance, a user is able to create a three-dimensional representation of a digital object by defining its three-dimensional shape as well as various visual properties of the digital object. The user is further able to view a digital environment that includes the digital object. Accordingly, such three-dimensional modeling applications are widely used for a variety of industries and applications, such as animation, interior design, product design, engineering, architecture, etc. However, manually navigating three-dimensional modelling applications, such as to obtain a desired view, can be time-consuming, computationally inefficient, and limited by a user's experience with the three-dimensional modeling application.

### SUMMARY

Techniques for text-based reference image generation are described that support generation of reference digital images of a three-dimensional representation of a digital environment that are based on semantic properties of a text-based input and a perceptual similarity of the reference digital images to the text-based input. For example, a processing device receives a text-based input that describes a feature of a three-dimensional representation of a digital environment. The processing device generates a reference digital image that depicts a view of the feature. The reference digital image is based on a perceptual similarity between the reference digital image and semantic properties of the text-based input. The processing device outputs the reference digital image in a user interface. The processing device is further operable to apply one or more edits to the reference digital image based on features of the digital environment as well as on additional user inputs using a variety of editing modalities and/or techniques, such as to provide visual examples of proposed edits to the digital environment. In this way, the techniques described herein efficiently generate and edit reference images based on properties of user inputs and the three-dimensional representation of the digital environment.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ the text-based reference image generation techniques described herein.

FIG. 2 depicts a system in an example implementation showing operation of a generation module of FIG. 1 in greater detail.

FIG. 3 depicts an example of generation of reference digital images based on text-based inputs.

FIG. 4 depicts an example to apply an edit to a reference image based on one or more strokes applied to define a region for the edit.

FIG. 5 depicts an example to apply an edit to a reference image based on an edit input that includes a bounding box to define a region for the edit.

FIG. 6 depicts an example to apply an edit to a reference image using an inpainting model.

FIG. 7 is a flow diagram depicting an algorithm as a step-by-step procedure in an example implementation that is performable by a processing device to generate a reference digital image and to apply one or more edits to the reference digital image.

FIG. 8 is a flow diagram depicting an algorithm as a step-by-step procedure in an example implementation that is performable by a processing device to generate a reference digital image.

FIG. 9 is a flow diagram depicting an algorithm as a step-by-step procedure in an example implementation that is performable by a processing device to apply one or more edits to a reference digital image based on one or more strokes.

FIG. 10 is a flow diagram depicting an algorithm as a step-by-step procedure in an example implementation that is performable by a processing device to apply one or more edits to a reference digital image based on one or more bounding boxes applied to define a region for the edit.

FIG. 11 is a flow diagram depicting an algorithm as a step-by-step procedure in an example implementation that is performable by a processing device to apply one or more edits to a reference digital image using an inpainting model.

FIG. 12 illustrates an example system including various components of an example device that can be implemented as any type of computing device as described and/or utilized with reference to FIGS. 1-11 to implement embodiments of the techniques described herein.

### DETAILED DESCRIPTION

### Overview

Content processing systems often use three-dimensional modeling applications to generate, manipulate, and render three-dimensional digital objects in a virtual space. Such applications, for instance, allow users to construct digital representations of objects by defining properties of the objects such as a geometric shape/orientation, surface textures, materials, lighting properties, etc. Accordingly, three-dimensional modeling applications are utilized in a variety of industries and collaborative workflows, such as scenarios in which multiple users provide feedback on a three-dimensional digital scene. However, conventional navigation and editing within three-dimensional modelling applications remains challenging, particularly for users with limited experience.

For instance, conventional techniques to navigate a three-dimensional digital environment, such as to obtain a desired view of a digital object, involve manual navigation and manipulation of a virtual “viewing camera” that has six degrees of freedom. Such manual navigation is time-consuming, computationally inefficient, and limited by a user's experience with the three-dimensional modeling application. Further, editing digital objects and/or elements of the digital environment requires advanced technical skill and experience with the three-dimensional modeling application. Thus, conventional three-dimensional modelling applications and associated collaborative workflows are constrained by reliance on conventional navigation methods and limited visual feedback with respect to proposed edits.

Accordingly, techniques and systems for text-based reference image generation are described that overcome these limitations to generate reference images of a three-dimensional digital environment that are based on semantic properties of a text-based input and a perceptual similarity of the reference images to the text-based input. In this way, the techniques described herein are able to efficiently generate and edit reference images based on properties of user inputs and visual properties of the three-dimensional digital environment. This overcomes the limitations of conventional techniques, which are limited to manual navigation of a scene which requires advanced technical knowledge and limited operations to convey proposed edits to the three-dimensional digital environment.

Consider an example in which a user, e.g., “Emma,” is renovating a room in her house and engages an interior design contractor e.g., “Michael,” to assist. Michael leverages a three-dimensional design application to generate a three-dimensional representation of a digital environment, such as a model of a living room that includes various digital objects such as furniture, plants, art, etc. Michael then sends the three-dimensional representation to Emma for feedback.

Using conventional approaches, Emma is forced to leverage a processing device to operate a virtual viewing camera to manually navigate within the three-dimensional design application to a desired viewpoint. Such manual navigation is time-consuming, computationally inefficient, and limited by a user's experience with the three-dimensional modeling application. Further, to suggest a change for Michael to make to the model, such as to suggest adding a particular television to a discrete region of the three-dimensional digital environment, Emma is forced to describe the change using words and/or to search for stock images that approximate the desired change. Such techniques are inefficient, inaccurate, and do not incorporate underlying features of the three-dimensional digital environment.

To overcome these limitations, a processing device receives an input that includes a three-dimensional representation of a digital environment, e.g., a 3D model, and a user input, e.g., a text-based input, that describes a feature of the digital environment. In this example, the model is a three-dimensional depiction of the living room and the user input includes a plain language text string that specifies a feature of the living room, e.g., “We could add a flatscreen television on the brown sideboard so that people sitting on the yellow sofa are able to see the television.”

The processing device then generates a reference digital image that depicts a view of the feature based on a perceptual similarity between the reference digital image and semantic properties of the text-based input. The view of the reference digital image, for instance, represents an “optimal” view of the feature to align with human perceptual tendencies and to provide a clear visual perspective of the feature. In this example, the reference digital image depicts a view of the brown sideboard from an orientation that is intuitively understood by the human eye.

In an example to generate the reference digital image, the processing device generates a variety of viewpoint digital images that each depict a viewpoint of the digital environment, such as digital images with varying perspectives, orientations, and zoom conditions of the model of the living room. The processing device further leverages a contrastive language-image pretraining (“CLIP”) model to identify and comprehend various semantic properties of the text-based input to correlate the user input to one or more of the viewpoint digital images. The semantic properties, for instance, include one or more properties of the text-based input such as presence/absence of keywords or text strings, relationships between different elements of the text-based input, visual descriptors, a language style of the text-based input, sentiment analysis information, task classification information, etc.

The processing device leverages the CLIP model to generate similarity scores (e.g., based on a cosine similarity metric) for each of the viewpoint digital images based on a perceptual similarity between respective viewpoints of the viewpoint digital images and the semantic properties of the text-based input. Accordingly, a relatively higher similarity score is indicative that a particular viewpoint digital image includes a desirable viewpoint of the feature. For example, a viewpoint digital image with a relatively high similarity score depicts the brown sideboard from a front facing view with a zoom level such that the entire sideboard is visible, whereas a viewpoint digital image with a relatively low similarity score depicts a portion of the underside of the brown sideboard.

Based on the similarity scores, the processing device is operable to output one or more reference digital images, such as in a user interface of the processing device. In one example, the processing device generates the reference digital image as one of the viewpoint digital images with a similarity score above a threshold, e.g., a viewpoint digital image with a highest similarity score. Accordingly, the reference digital image depicts the sideboard from a desirable viewpoint. In an additional or alternative example, the processing device outputs two or more candidate digital images that have similarity scores above a threshold, such as to provide a user with multiple options for a selectable view.

Continuing with the above example, the processing device receives an input to select the reference digital image. The processing device then navigates the three-dimensional modeling application to depict a view that replicates the reference digital image, such as to orient the 3D model to depict a view of the brown sideboard that is substantially similar to the view of the reference digital image. Accordingly, the techniques described herein are usable to automatically generate reference digital images that depict desirable viewpoints of a digital environment based on properties of a text input and features of the digital environment and are further usable to automatically navigate within a three-dimensional modelling environment based on a text input.

In some examples, the processing device is further operable to apply one or more edits to the reference digital image that are based on features from the digital environment as well as on additional user inputs using a variety of editing modalities and/or techniques, such as to provide visual examples of proposed edits to the digital environment. For instance, the processing device receives an edit input that specifies a change to a feature of the three-dimensional representation of the digital environment. In various examples, the processing device receives the edit input as a supplemental text prompt, such as a text string that is received in the user interface. Additionally or alternatively, the processing device extracts the edit input from the user input used to generate the reference digital image, such as by leveraging a large language model.

In one example, the edit input includes a text string and a user input to draw a region on the reference digital image. The text string in this example specifies a localized edit to the reference digital image, such as to add “a framed painting that depicts an ocean scene.” The processing device generates a selection mask defined by the region and leverages a stable diffusion inpainting model to apply an edit to the region, such as to add a framed painting as specified by the text string to the region specified by the user input. In this way, the processing device is operable to efficiently add and/or remove objects from the reference digital image.

In an additional or alternative example, the edit input includes a text string and a user input to draw one or more strokes on the reference digital image. The text string, for instance, indicates to add “a flatscreen television” and the one or more strokes include user “scribbles” to the user interface that define an approximate shape for the edit, such as an approximate size, spatial location, and/or orientation for the television to be added to the reference digital image. The processing device generates a depth map of the reference digital image based on the three-dimensional representation.

The processing device then inputs the depth map, the one or more strokes, and the text string to a depth conditioned image generation neural network to generate an edited reference digital image. Whereas conventional text-guided image synthesis techniques generate images based solely on text inputs, the image generation neural network as described herein is conditioned on the underlying three-dimensional representation to incorporate features of the digital environment to the edited reference digital image. The edited reference digital image, for instance, includes the view of the reference digital image with a flatscreen television integrated at a location and dimensions specified by the one or more strokes.

In yet another example, the edit input includes a text string and the processing device leverages the depth conditioned image generation neural network to generate a synthesized digital image that retains structural relationships of the reference digital image however incorporates aspects of the text string. For instance, the text string includes the text “a living room with a blue wall paint.” The synthesized digital image in this example depicts a living room with blue wall paint, however other aspects of the digital environment have been changed, e.g., different furniture, different art, etc.

Accordingly, the edit input further includes one or more bounding boxes applied to the synthesized digital image that indicate regions to incorporate to the edited reference digital image and/or regions to exclude from the edited reference digital image. In this example, a bounding box is applied to the wall region of the synthesized digital image and indicates to incorporate the blue wall paint to the edited reference digital image. Thus, the processing device generates the edited reference digital image to include the blue wall paint while retaining aspects of the reference digital image, e.g., original furniture, art, etc.

Accordingly, such techniques support localized edits that are based on specified constraints present in various user inputs as well as features of the three-dimensional digital environment. Thus, the techniques described herein increase efficiency and user satisfaction in a collaborative three-dimensional modeling scenario, such as to propose visual changes to a three-dimensional digital environment. Further discussion of these and other examples and advantages are included in the following sections and shown using corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

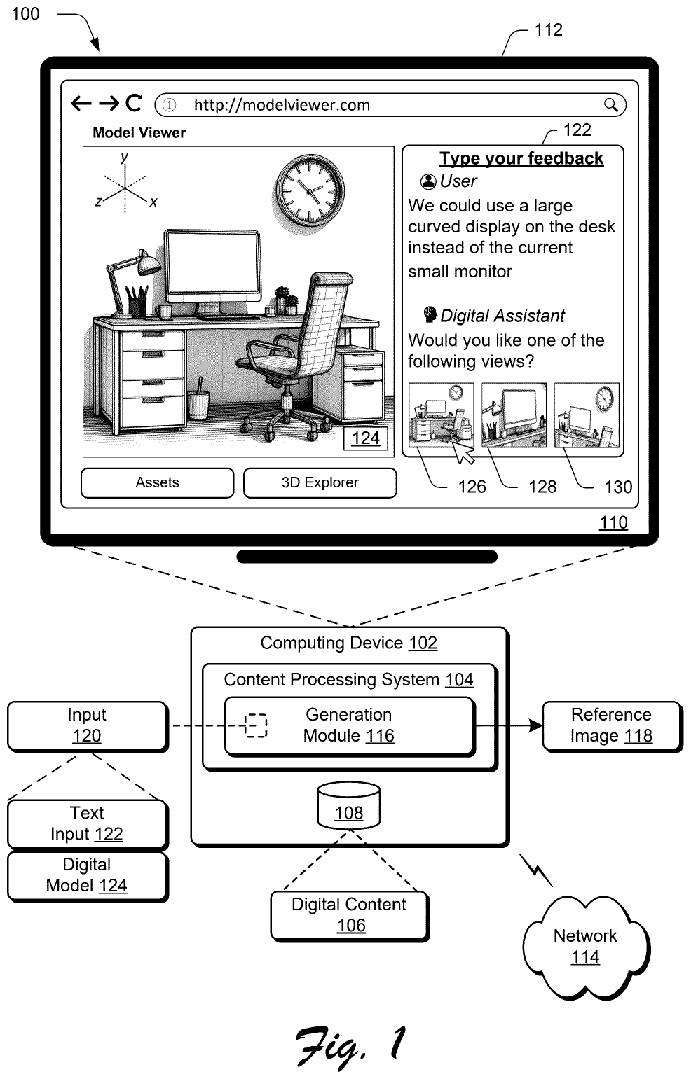

FIG. 1 is an illustration of a digital medium environment 100 in an example implementation that is operable to employ the text-based reference image generation techniques described herein. The illustrated environment 100 includes a computing device 102, which is configurable in a variety of ways.

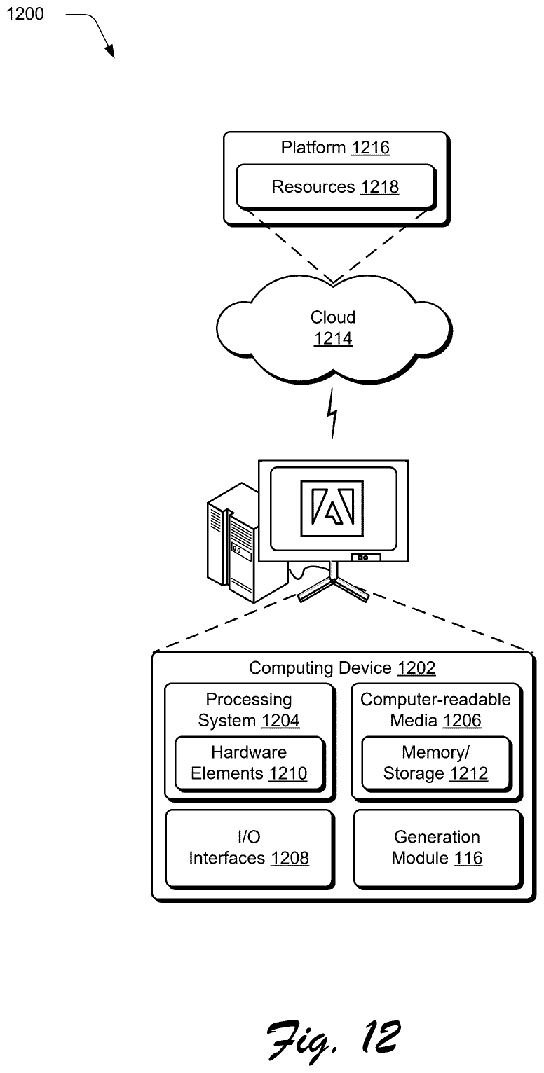

The computing device 102, for instance, is configurable as a processing device such as a desktop computer, a laptop computer, a mobile device (e.g., assuming a handheld configuration such as a tablet or mobile phone), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 12.

The computing device 102 is illustrated as including a content processing system 104. The content processing system 104 is implemented at least partially in hardware of the computing device 102 to process, generate, and/or transform digital content 106, which is illustrated as maintained in storage 108 of the computing device 102. Such processing includes creation of the digital content 106, modification of the digital content 106, and rendering of the digital content 106 in a user interface 110 for output, e.g., by a display device 112. Although illustrated as implemented locally at the computing device 102, functionality of the content processing system 104 is also configurable in whole or in part via functionality available via the network 114, such as part of a web service or “in the cloud.”

An example of functionality incorporated by the content processing system 104 to process the digital content 106 is illustrated as a generation module 116. This module is configured to generate a reference image 118 based on an input 120 that includes a text input 122, e.g., a text-based input that includes a text string, and a digital model 124, e.g., a three-dimensional representation of a digital environment. The digital environment, for instance, includes a variety of features such as one or more digital objects, scene elements, lighting conditions, backgrounds, textures, materials, environmental settings, simulations, animations, etc. The computing device 102 includes various functionality (such as one or more applications, e.g., stored applications and/or browser-based applications) to generate, load, render, interact, navigate, and/or manipulate the digital model 124. In various examples, the user interface 110 includes a rich-text editor interface, such as to receive various text-based inputs and/or text prompts.

Generally, the reference image 118 depicts a view of a feature described by the text input 122 that is located within the digital environment. The view of the reference image 118 is based on a perceptual similarity between the reference image 118 and semantic properties of the text input 122. For instance, the view of the reference image 118 represents an “optimal” view of the feature to align with human perceptual tendencies and to provide a clear visual perspective of the feature. In one or more examples, the view depicts the feature from an orientation that is intuitively understood by the human eye.

For instance, in the illustrated example the generation module 116 receives a text input 122 that includes a text string “we could use a large, curved display on the desk instead of the current small monitor.” The generation module 116 further receives a digital model 124, e.g., a three-dimensional representation of a digital environment that includes an office scene. Based on semantic properties of the text input 122 (e.g., presence of keywords or text strings, relationships between different text strings, a language style of the text input 122, sentiment analysis information, task classification information, etc.) the generation module 116 generates several candidate reference images, e.g., a first image 126, a second image 128, and a third image 130, that each depict viewpoints of a feature of the digital model 124, such as the display on the desk.

The generation module 116, for instance, generates the candidate reference images based on a perceptual similarity of the candidate digital images to the semantic properties of the text input 122. As further described in more detail below, in at least one example, the generation module 116 leverages a contrastive language-image pretraining (“CLIP”) model to generate similarity scores for each of a plurality of digital images that depict different viewpoints of the feature, and outputs two or more candidate digital images (e.g., the first image 126, second image 128, and the third image 130) that have a similarity score above a threshold. Accordingly, the candidate digital images have an increased likelihood of having a desirable viewpoint of the feature.

In the illustrated example, the generation module 116 further receives an input to select the first image 126 in the user interface 110. Accordingly, the first image 126 is representative of the reference image 118. Responsive to the selection, the generation module 116 navigates the digital model 124 to a perspective to replicate the view of the reference image 118. While not shown in the illustrated example, the generation module 116 is further operable to apply one or more edits to the reference image 118 based on the text input 122, the view of the reference image 118, and/or one or more additional inputs to specify a change to the reference image 118. In this way, the techniques described herein provide a modality to efficiently generate and edit reference images 118 based on semantic properties of text-based inputs and visual properties of a three-dimensional digital environment as well as to efficiently navigate a three-dimensional digital environment. Further discussion of these and other advantages is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Text-Based Reference Image Generation

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. In portions of the following discussion, reference will be made to FIGS. 1-11.

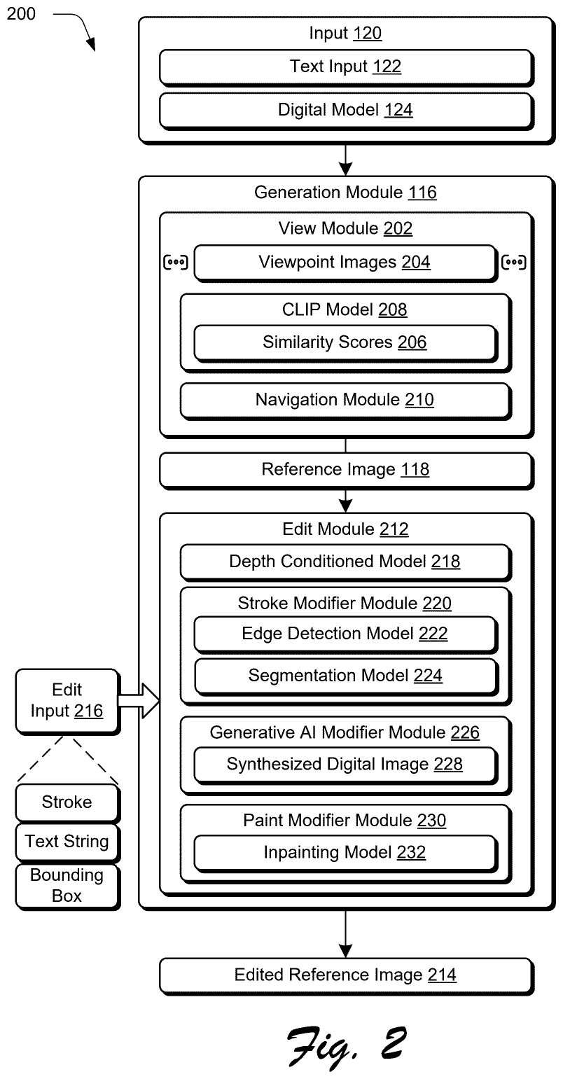

FIG. 2 depicts a system 200 in an example implementation showing operation of a generation module 116 of FIG. 1 in greater detail. Generally, the generation module 116 is operable to generate a reference image 118 based on a perceptual similarity between the reference image 118 and an input 120. As described in more detail below, the generation module 116 is further operable to leverage the reference image 118 for a variety of functionality and is further operable to apply one or more edits to the reference image 118.

In an example, the generation module 116 receives an input 120 that includes a text input 122 and a digital model 124. The digital model 124, for instance, includes a three-dimensional representation of a digital environment. In various examples, the digital model 124 includes one or more features such as digital objects, scene elements, lighting conditions, backgrounds, textures, materials, environment settings, simulations, animations, etc. The computing device 102 is operable to display and/or interact with the digital model 124, such as to leverage one or more applications and/or web-based extensions to display and/or navigate the digital model 124.

The text input 122, for instance, includes a text string that describes one or more features of the digital model 124. A variety of visual and/or non-visual features of the digital model 124 are considered, such as one or more digital objects, scene elements, lighting conditions, environmental features, backgrounds, textures, materials, spatial relationships of scene elements, absence of particular scene elements, etc. In various embodiments, the one or more features are associated with a spatial location of the digital model 124, e.g., located at a particular location within the digital model 124. In at least one example, the generation module 116 receives the text input 122 via one or more inputs to a user interface 110 of the computing device 102, using one or more speech-to-text modalities, using optical character recognition, using gesture-based input, handwriting recognition, etc.

The generation module 116 then generates a reference image 118 that depicts a view of the feature based on a perceptual similarity between the reference image 118 and semantic properties of the text input 122. The view depicted by the reference image 118, for instance, aligns with human perceptual tendencies to provide a desirable rendering of the feature. In one or more examples, the view is definable as one or more of a position of a virtual camera (such as a three-dimensional position within the digital environment) an orientation of the virtual camera (e.g., a longitudinal and/or latitudinal rotation), and/or a zoom component, e.g., a distance from the feature to the virtual camera.

In an example to generate the reference image 118, the generation module 116 includes a view module 202 that generates one or more viewpoint images 204 that each depict a viewpoint of the digital environment. Each of the viewpoint images 204 is parameterized by a three-dimensional target position of a virtual camera (tₓ, t_{y}, t_{z}), a distance r to the virtual camera, a longitudinal rotation α, and a latitudinal rotation β. Accordingly, a particular viewpoint of a viewpoint image 204 is representable as a tuple v=(α, β, r, tₓ, t_{y}, t_{z}) with α∈[0, π] and β∈[0,2π].

In one example to generate the viewpoint images 204, the view module 202 computes a bounding box of the digital model 124 and discretizes an x-axis, y-axis, and z-axis into a number of bins, e.g., five bins, such that there are 5³ sampled positions (tₓ, t_{y}, t_{z}). The view module 202 further samples α and β at intervals, e.g., 30-degree intervals for a total of 72 possible orientations. The view module 202 samples the distance to the virtual camera r at varying distances, such as from {0.5, 1.0, 1.5} to create “close”, “medium”, and “far” views. The view module 202 concatenates the viewpoint images 204 into a matrix such as a matrix D∈ [symbol] that includes 27,000 viewpoint images that are each encoded into a 500-dimensional vector.

The view module 202 further generates similarity scores 206 for one or more (e.g., each) of the viewpoint images 204. The similarity scores 206, for instance, are based on a perceptual similarity between the respective viewpoints of the viewpoint images 204 and the text input 122. To do so, the view module 202 leverages a multimodal machine learning model such as a contrastive language-image pretraining model (“CLIP”) model 208.

Generally, the CLIP model 208 is trained to comprehend a relationship between text and images based on linguistic and/or contextual aspects of the text and visual properties of the images. For instance, the CLIP model 208 is trained to identify and leverage various semantic properties of a text input 122 to interpret the text input 122 to generate a similarity comparison, e.g., a cosine similarity, to various images. The semantic properties, for instance, include one or more properties of the text input 122 such as presence/absence of keywords or text strings, relationships between different elements of the text input 122, visual descriptors, a language style of the text input 122, sentiment analysis information, task classification information, etc.

Accordingly, the view module 202 generates an encoding of the text input 122, denoted t in this example. In one or more examples, the view module 202 generates the encoding in real time such as while a user is typing. In at least one example, the view module 202 implements a timing threshold to update the encoding when a user stops typing. For example, the view module 202 implements a timing threshold of 500 ms to update the encoding when text input isn't received for 500 ms. In this way, the techniques described herein are responsive to dynamic user inputs to generate updated reference images 118 as text input is added, removed, an/or changed.

The view module 202 inputs the encoding of the text input 122 and the encoded viewpoint images 204 (e.g., the viewpoint image matrix) to the CLIP model 208. The CLIP model 208 generates the similarity scores 206 for each of the viewpoint images 204. The similarity scores 206, for instance, are based on a cosine similarity of the respective viewpoints of the viewpoint images 204 to the text input 122. Continuing the above notation, the CLIP model 208 searches \hat{v}=argmax_{v∈V} cos{fₜₑₓₜ(t), f_{image}(Iᵥ)} where fₜₑₓₜ(⋅) represents the encoding of the text input 122, f_{image}(⋅) represents the encoding of the viewpoint images 204, and (Iᵥ) represents a screen space image (e.g., a viewpoint image 204) associated with a particular viewpoint v.

In this way, the CLIP model 208 is able to identify one or more viewpoint images 204 that are perceptually similar to the text input 122. The view module 202 selects one or more of the viewpoint images 204 as the reference image 118. In one example, the view module 202 selects a viewpoint image 204 with a highest similarity score 206 to generate the reference image 118.

Additionally or alternatively, the view module 202 selects two or more candidate digital images from the viewpoint images 204 that have similarity scores 206 above a threshold. The view module 202 is operable to output the two or candidate digital images, such as in the user interface 110 of the display device 112. In at least one example, the view module 202 receives an additional user input to select a candidate digital image from the two or more candidate digital images. The view module 202 then generates the reference image 118 based on the selected candidate digital image. In this way, the techniques described herein are usable to present multiple viewpoint options to a user of the computing device 102.

The generation module 116 further includes a navigation module 210 that is operable to navigate within the digital model 124 based on the reference image 118. For instance, the navigation module 210 navigates within the digital model 124 to display an orientation that corresponds to the view depicted by the reference image 118. In an example, the navigation module 210 performs the navigation responsive to detection of an input, such as in the user interface 110, to select the reference image 118. In an additional or alternative example, the navigation module 210 performs this functionality automatically and without user intervention. Thus, the techniques described herein are usable to automatically generate reference images 118 that depict desirable viewpoints of a digital environment based on properties of a text input 122 and features of the digital environment as well as automatically navigate within the digital model 124.

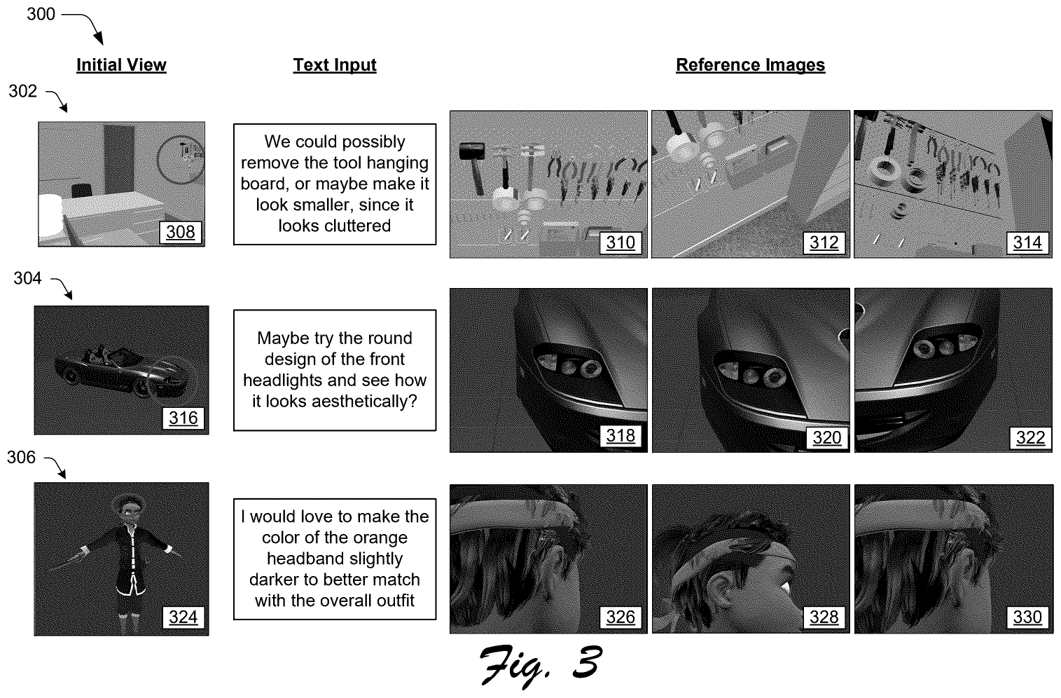

FIG. 3 depicts an example 300 of generation of reference digital images based on text-based inputs in a first example 302, a second example 304, and a third example 306. In the first example 302, an initial view 308 of a three-dimensional representation of a digital environment, e.g., a digital model 124 of a workshop scene, is depicted. The generation module 116 receives a text input 122 that includes a text string “we could possibly remove the tool hanging board, or maybe make it look smaller, since it looks cluttered.” Accordingly, the text input 122 describes a feature of the three-dimensional representation, e.g., the tool hanging board. A red circle in the initial view 308 denotes a location of the feature.

In accordance with the techniques described herein, the generation module 116 generates several reference images 118, such as a first reference image 310, a second reference image 312, and a third reference image 314. In this example, the first, second and third reference images 310, 312, and 314 have a CLIP cosine similarity score above a threshold, e.g., equal to or above 0.3095. Accordingly, the reference images exhibit a relatively high perceptual similarity to semantic properties of the text input 122.

The second example 304 depicts an initial view 316 of a three-dimensional representation of a digital environment, e.g., a digital model 124 of an automobile. The generation module 116 receives a text input 122 that includes a text string “maybe try the round design of the front headlights and see how it looks aesthetically?” Accordingly, the text input 122 describes a feature of the three-dimensional representation, e.g., the front headlight of the car. A red circle in the initial view 316 denotes a location of the feature.

In accordance with the techniques described herein, the generation module 116 generates several reference images 118, such as a first reference image 318, a second reference image 320, and a third reference image 322. As in the first example 302, in this second example 304 the first, second and third reference images 318, 320, and 322 have a CLIP cosine similarity score above a threshold. Accordingly, the reference images exhibit a relatively high perceptual similarity to semantic properties of the text input 122 and display a desirable view of the front headlight.

The third example 306 depicts an initial view 324 of a three-dimensional representation of a digital environment, e.g., a digital model 124 of a character wearing a headband and holding a sword. The generation module 116 receives a text input 122 that includes a text string “I would love to make the color of the orange headband slightly darker to better match with the overall outfit.” Accordingly, the text input 122 describes a feature of the three-dimensional representation, e.g., the orange headband. A red circle in the initial view 324 denotes a location of the feature.

In accordance with the techniques described herein, the generation module 116 generates several reference images 118, such as a first reference image 326, a second reference image 328, and a third reference image 330. As in the first example 302 and the second example 304, in this third example 306 the first, second and third reference images 326, 328, and 330 have a CLIP cosine similarity score above a threshold. The reference images thus exhibit a relatively high perceptual similarity to semantic properties of the text input 122 and display a desirable view of the headband. Accordingly, the techniques described herein are able to generate reference images 118 that depict desirable views for a variety of types of digital models 124.

### Reference Digital Image Editing

In one or more examples, the generation module 116 further includes an edit module 212 that is operable to apply one or more edits to the reference image 118 to generate an edited reference image 214. The one or more edits, for instance, are based on one or more of the digital model 124, the text input 122, the view of the reference image 118, and/or an additional input to the edit module 212 such as an edit input 216. In various examples, the edit module 212 leverages one or more rapid design layers to apply the one or more edits. As discussed in the following examples, a variety of editing modalities and techniques are contemplated.

Generally, the edit input 216 specifies a change to a feature of the three-dimensional representation of the digital environment. In various examples, the edit module 212 receives the edit input 216 supplemental to the input 120 such as an additional text string that is received in the user interface 110, one or more strokes drawn on the digital model 124 and/or on the reference image 118, an action to create a bounding box on the digital model 124 and/or on the reference image 118, an action to define a region on the digital model 124 and/or on the reference image 118, etc.

Additionally or alternatively, the edit module 212 extracts the edit input 216 from the input 120 used to generate the reference image 118, such as by leveraging a large language model. For instance, the edit module 212 leverages one or more large language models to comprehend the text input 122 and/or to extract one or more portions of the text input 122 that describe one or more changes to the digital model 124. Based on the edit input 216, the edit module 212 is operable to apply the change to the reference image 118 using one or more of the following techniques.

In various examples, the edit module 212 leverages a depth conditioned model 218 to generate the edited reference image 214. Generally, the depth conditioned model 218 is operable to generate images based on a text input, e.g., such as an image generation neural network, that is further based on an underlying geometry of a digital image, such as an underlying geometry of the reference image 118. In various embodiments, the depth conditioned model 218 is a depth conditioned ControlNet model such as described by Zhang, et. al. Adding Conditional Control to Text-to-Image Diffusion Models. In IEEE International Conference on Computer Vision (ICCV). pp. 3836-3847. (2023).

Accordingly, in an example the edit module 212 is operable to receive as input the reference image 118 and an edit input 216 that includes a text string and generate an edited reference image 214 by leveraging the depth conditioned model 218. For instance, the depth conditioned model 218 applies a global texture edit to the scene depicted by the reference image 118 without geometry modification. That is, the depth conditioned model 218 in this example edits visual elements of the reference image 118 while retaining an underlying geometry of the reference image 118, e.g., a spatial relationship of one or more elements within the reference image 118.

In various examples, the edit input 216 specifies an edit to apply to a particular part and/or location of the reference image 118, e.g., to edit a digital object within the reference image 118. Accordingly, the edit module 212 includes various functionality to apply localized edits to the reference image 118. For instance, the edit input 216 is operable to receive as input the reference image 118 and an edit input 216 that includes one or more strokes. The one or more strokes, for instance, are “drawn” on a visual representation of the reference image 118, such as in the user interface 110 of the display device 112. The one or more strokes define an approximate shape for the edit, such as an approximate size, spatial location, and/or orientation for the edit. The one or more strokes, for instance, include one or more user scribbles applied to the user interface using one or more interactive interface tools. As further described in the following example, the edit module 212 generates the edited reference image 214 based on an underlying geometry of the reference image 118 (e.g., a depth map of the reference image 118) and the edit input 216.

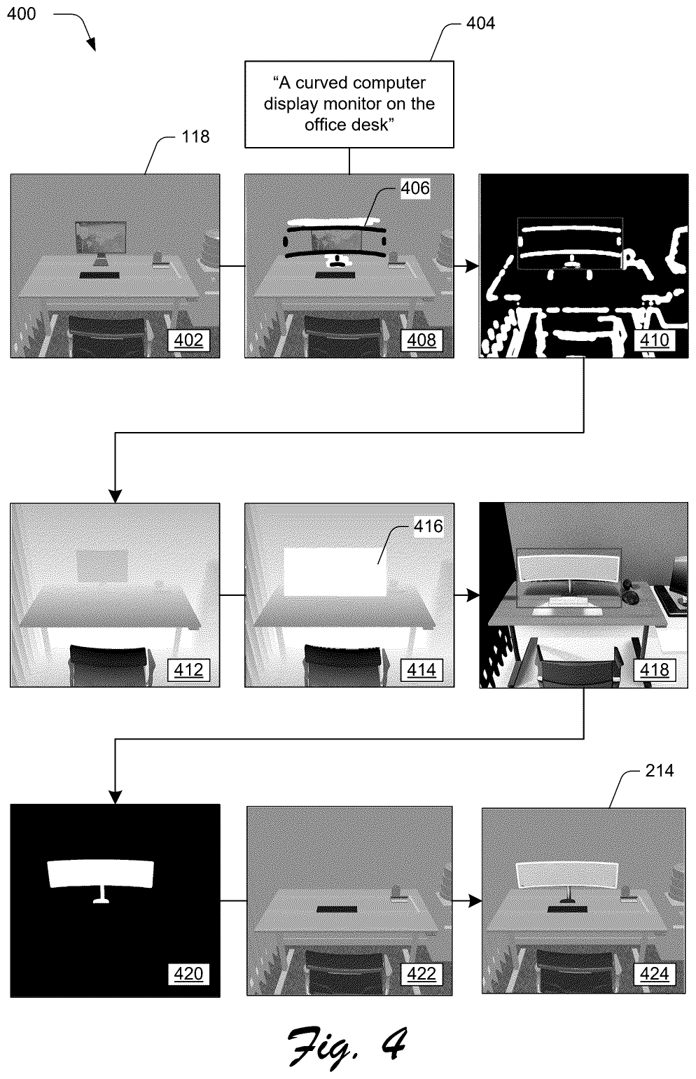

For instance, FIG. 4 depicts an example 400 to apply an edit to a reference image 118 based on one or more strokes applied to define a region for the edit. In this example, the edit module 212 receives a reference image 118, which is represented in the illustrated example 400 as an initial image 402. The initial image 402, for instance, is a reference image 118 generated in accordance with the techniques described above and depicts a view of an office desk with a flat computer monitor, keyboard, and other office related features.

The edit module 212 includes a stroke modifier module 220 that is operable to receive an edit input 216 that in this example includes a text prompt 404 and several strokes 406, e.g., several user scribbles. The text prompt 404, for instance, describes a desired change to a feature of the three-dimensional representation of the digital environment, e.g., to change the flat computer monitor of the initial image 402 to “a curved computer display monitor on the office desk.” The strokes 406, depicted in the stroked image 408, define a region for the change, and in the illustrated example the black strokes include a desired shape of the curved computer display. The strokes 406 in this example further include several removal strokes, depicted in the illustrated example as white strokes, that indicate regions for content from the initial image 402 to be omitted from the edited reference image 214, e.g., regions of the flat computer monitor to be removed from the edited reference image 214.

The stroke modifier module 220 generates an edge image 410 that identifies boundaries and/or edges of the initial image 402 aggregated with the strokes 406. In the illustrated example, a red box denotes a location of the strokes 406. The stroke modifier module 220 further omits edges and/or boundaries denoted by the removal strokes, e.g., the white strokes, to generate the edge image 410. In at least one example, the stroke modifier module 220 leverages an edge detection model 222 to generate the edge image 410. In various embodiments, the edge detection model 222 is a holistically-nested edge detection (“HED”) model such as described by Xi, et. al. Holistically-Nested Edge Detection. In Proceedings of IEEE International Conference on Computer Vision (2015). In this way, the stroke modifier module 220 generates the edge image 410 to represent a geometry of the reference image 118 that incorporates the region defined by the strokes 406.

The stroke modifier module 220 further generates a depth map 412 based on a digital model 124 associated with the reference image 118. The depth map 412, for instance, is a representation that encodes a distance of objects and/or surfaces in the reference image 118 (e.g., the initial image 402) to a virtual camera. Each pixel in the depth map 412, for instance, corresponds to a point in the initial image 402 and indicates a relative depth of the respective point from the virtual camera. In the illustrated example, lighter pixels represent points that are relatively further from the virtual camera while darker pixels represent points that are relatively closer to the virtual camera. The stroke modifier module 220 is further operable to generate a modified depth map 414 that “resets” a region defined by the strokes 406. For instance, in the illustrated example a region 416 denoted with a white box is defined by the strokes 406 and removes depth information from the depth map 412.

The stroke modifier module 220 leverages the depth conditioned model 218 to generate a synthesized image 418 based on the text prompt 404, the strokes 406, and the depth map 412. For instance, the depth conditioned model 218 receives an embedding of the text prompt 404, the edge image 410, and the modified depth map 414 as input and generates the synthesized image 418. In various examples, the stroke modifier module 220 applies one or more weights to the depth conditioned model 218, such as a weight for a stroke condition and/or a weight for a depth condition. A relatively higher weight, for example, results in a relatively greater visual impact of the stroke condition and/or of the depth condition in generation of the synthesized image 418. In one example, the stroke condition is set to a weight of 0.7 while the depth condition is set to a weight of 0.3, such as to prioritize a visual impact of the strokes 406 during generation of the synthesized image 418.

The synthesized image 418 depicts the change specified by the text prompt 404, e.g., the curved computer display monitor on the office desk as denoted by the red box in the illustrated example. However, the synthesized image 418 also includes changes to other features of the initial image 402, e.g., a different desk chair, wall color, keyboard, flooring, etc. Accordingly, the stroke modifier module 220 is operable to extract an element, e.g., the curved computer display monitor, from the synthesized image 418 to be incorporated into the initial image 402.

In an example to do so, the stroke modifier module 220 leverages a segmentation model 224, e.g., a zero-shot image segmentation model, to generate a segmentation mask 420. The segmentation mask 420, for instance, labels regions that correspond to the element (e.g., the curved computer display monitor) while excluding regions that do not correspond to the element. In at least one example, the segmentation model 224 is a Segment Anything Model (“SAM”) such as described by Kirillov, et. al. Segment Anything. arXiv preprint arXiv: 2304.02643 (2023).

To generate the segmentation mask 420, the stroke modifier module 220 computes a bounding box around the region 416 that corresponds to the strokes 406. The stroke modifier module 220 then leverages the segmentation model 224 to detect salience within the bounding box. For example, the segmentation model 224 identifies a salient object (e.g., a most salient object) within the bounding box, which in this example is the curved computer display monitor. Based on the identified salient object, the stroke modifier module 220 generates the segmentation mask 420.

The stroke modifier module 220 is configured to incorporate the element from the synthesized image 418, e.g., the curved computer display monitor, into the initial image 402. In some embodiments, the stroke modifier module 220 is operable to remove one or more features from the reference image 118. For instance, the stroke modifier module 220 removes one or more digital objects from the initial image 402, such as the flat computer monitor, to generate a segmented image 422. In at least one example, the segmented image 422 is based in part on one or more of the segmentation mask 420 and/or the removal strokes, e.g., the white strokes in the stroked image 408.

The stroke modifier module 220 generates an edited reference image 214, e.g., the edited image 424, based on the segmentation mask 420, the synthesized image 418, the initial image 402, and/or the segmented image 422. The edited image 424, for instance, depicts a scene of the initial image 402, e.g., the office setting, with a curved computer display monitor such as specified by the text prompt 404. The curved computer display monitor is further depicted as adherent to a depth and orientation of the scene so as to not appear out of place.

In an example, the stroke modifier module 220 generates the edited image 424 in a stroke design layer (e.g., a scribble design layer) via composition: I_{syn}⊙I_{seg}+Iᵢₙᵢₜ⊙(1−I_{seg}) where I_{syn} is representative of the synthesized image 418, I_{seg} is representative of the segmentation mask 420, and Iᵢₙᵢₜ is representative of the initial image 402. In this example, ⊙ represents broadcasting and element-wise multiplication. In various examples, the stroke modifier module 220 substitutes I′ᵢₙᵢₜ, which in this example is representative of the segmented image 422, for Iᵢₙᵢₜ to generate the edited image 424. In this way, the techniques described herein prevent and/or reduce an incidence of visual artifacts in the edited image 424.

In various examples, the edit module 212 includes a generative AI modifier module 226 that is operable to generate the edited reference image 214 based in part on an edit input 216 that defines a region of interest within a generative AI design layer. In an example, the generative AI modifier module 226 generates a depth map of the reference image 118, such as in accordance with the techniques described above. The edit input 216 in this example includes a text prompt, and the generative AI modifier module 226 leverages the depth conditioned model 218 to generate a synthesized digital image 228 within the generative AI design layer that retains structural relationships of the reference image 118 and incorporates aspects of the text prompt.

The edit input 216 in this example further defines a region of interest within a generative AI design layer. For instance, the edit input 216 includes a bounding box applied to the synthesized digital image 228 within the generative AI design layer. The bounding box, for instance, indicates one or more regions to incorporate to the edited reference image 214 and/or one or more regions to exclude from the edited reference image 214. In one example, the generative AI modifier module 226 incorporates a digital object within the bounding box to the reference image 118 to generate the edited reference image 214. In an additional or alternative example, the generative AI modifier module 226 excludes a digital object within the bounding box from the edited reference image 214 and instead incorporates elements from outside the bounding box to the edited reference image 214. In this way, the techniques described herein enable user control over which aspects of a synthesized digital image 228 are incorporated into the edited reference image 214.

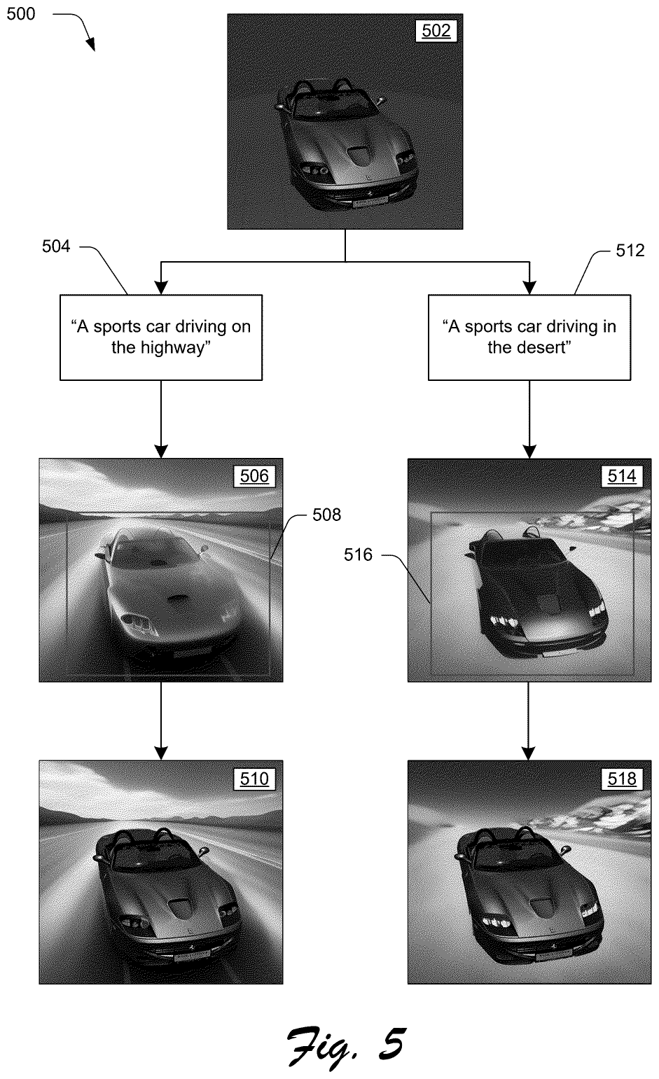

For instance, FIG. 5 depicts an example 500 to apply an edit to a reference image 118 based on an edit input 216 that includes a bounding box to define a region for the edit. In this example, a reference digital image 502 is generated in accordance with the techniques described above. The reference digital image 502 in this example depicts a sports car with a blue and grey background.

In a first example, the generative AI modifier module 226 receives an edit input 216 that includes a text prompt 504 for “a sports car driving on the highway.” In accordance with the techniques described above, the generative AI modifier module 226 leverages the depth conditioned model 218 to generate a synthesized image 506. For instance, the generative AI modifier module 226 generates the synthesized image 506 based on a depth map of the reference digital image 502 and the text prompt 504.

As illustrated, the synthesized image 506 depicts a sports car driving on the highway, as specified by the text prompt 504. The sports car further corresponds to a geometry and spatial relationship of the reference digital image 502. However, the sports car in the synthesized image 506 differs from the sports car in the reference digital image 502, e.g., with different headlights, contours, etc.

Accordingly, the generative AI modifier module 226 further receives an input to generate a bounding box 508 on the synthesized image 506 such as within the generative AI design layer. The generative AI modifier module 226 then generates an edited image 510 based on the synthesized image 506 and the bounding box 508. In this example, the bounding box 508 specifies a region of the synthesized image 506 to be excluded from the edited image 510 and filled with visual content from the reference digital image 502. For instance, the generative AI modifier module 226 removes the sports car from the synthesized image 506 and inserts the sports car from the reference digital image 502 into the edited image 510. Thus, the edited image 510 depicts the sports car from the reference digital image 502 driving on a highway.

In a second example, the generative AI modifier module 226 receives an edit input 216 that includes a text prompt 512 for “a sports car driving in the desert.” Similar to the first example described above, the generative AI modifier module 226 leverages the depth conditioned model 218 to generate a synthesized image 514 that depicts a sports car driving in the desert, as specified by the text prompt 512. The sports car in the synthesized image 514 has a substantially similar geometry and orientation to the sports car in the reference digital image 502, however has a different color, headlights, contours, etc.

Accordingly, the generative AI modifier module 226 further receives an input to generate a bounding box 516 on the synthesized image 514 such as within the generative AI design layer. The generative AI modifier module 226 then generates an edited image 518 based on the synthesized image 514 and the bounding box 516. Accordingly, the generative AI modifier module 226 generates the edited image 518 to include the sports car from the reference digital image 502 and the scene elements, e.g., the lighting and background of the desert, of the synthesized image 514.

Although not depicted in the illustrated example, in some embodiments the region of interest (e.g., defined by one or more bounding boxes) specifies a feature of the synthesized digital image 228 to include in the edited reference image 214. Consider an example in which a bounding box is applied to the generative AI layer and surrounds a digital object of interest in a synthesized digital image 228. The generative AI modifier module 226 inputs the bounding box to a segmentation model, e.g., the segmentation model 224, to generate a segmentation mask that identifies the digital object of interest. In various examples, this segmentation mask is unified with one or more additional segmentation masks, e.g., that identify additional digital objects. The generative AI modifier module 226 can then generate the edited reference image 214 to include the digital object of interest based in part on the segmentation mask.

In an additional or alternative example, the edit module 212 includes a paint modifier module 230 that leverages an inpainting model 232 to apply an edit to a particular region of the reference image 118. In an example, the edit input 216 includes a text string and an input, e.g., a user input to a painting design layer, to define a region on the reference image 118. The user input, for instance, includes an action to “paint” the region on the reference image 118, such as with one or more strokes. The text string in this example specifies a localized edit to the reference digital image, such as to add or remove a visual feature to/from the reference image 118. The paint modifier module 230 generates a selection mask defined by the region and leverages the inpainting model 232 to apply the edit to the region. The inpainting model 232, for instance, is a stable diffusion inpainting model such as described by Rombach, et. al. High-Resolution Image Synthesis with Latent Diffusion Models. arXiv preprint arXiv: 2112.10752 (2022). In this way, the processing device is operable to efficiently add and/or remove objects from the reference image 118.

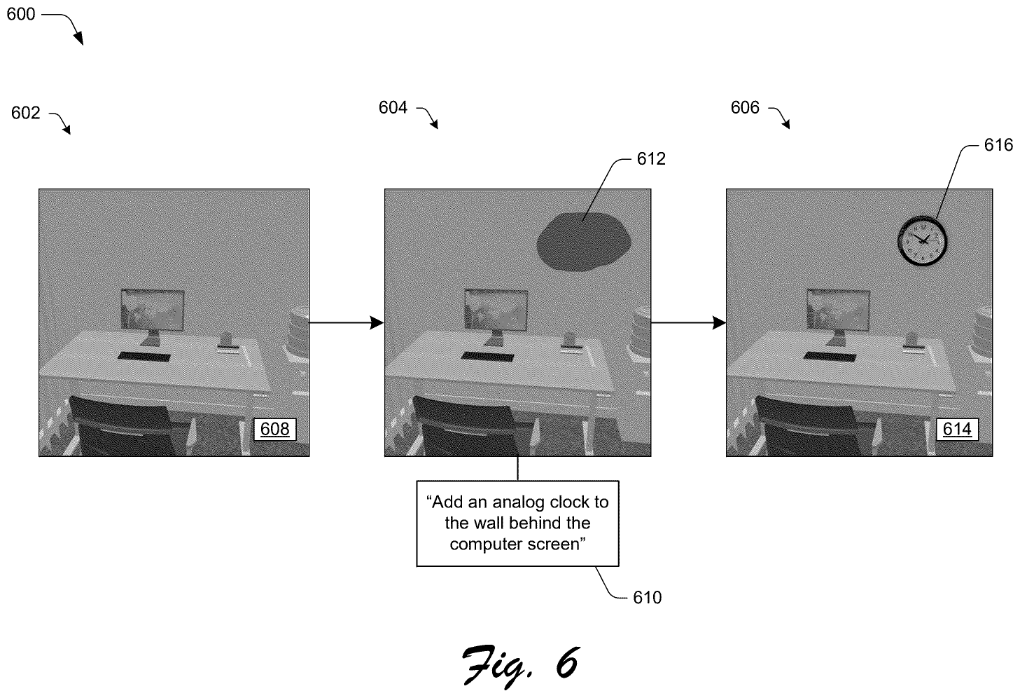

For instance, FIG. 6 depicts an example 600 to apply an edit to a reference image 118 using an inpainting model in a first stage 602, a second stage 604, and a third stage 606. As shown in the first stage 602, the paint modifier module 230 receives a reference image 118 such as the initial image 608 that depicts a computer desk with a computer, chair, and a blank wall behind the desk. As shown in the second stage 604, the paint modifier module 230 receives an edit input 216 that includes a text string 610 and a painted region 612. The text string 610 specifies an edit to apply to the initial image 608, such as to “add an analog clock to the wall behind the computer screen.” The painted region 612, for instance, is based on a user input to draw the painted region 612 on the reference image 118. The paint modifier module 230 generates a selection mask based on the painted region 612 to define a region for the edit to be applied.

As shown in the third stage 606, the paint modifier module 230 applies the edit to the region to generate an edited reference image 214, such as the edited image 614, using the inpainting model 232. The edit in this example is based on the text string 610, the region defined by the painted region 612, as well as the view depicted in the initial image 608. For instance, a visual representation of a clock 616 has been added to the wall behind the computer screen. Thus, the techniques described herein support rapid and computationally efficient reference image modification and thus enhance three-dimensional modeling collaborative workflows.

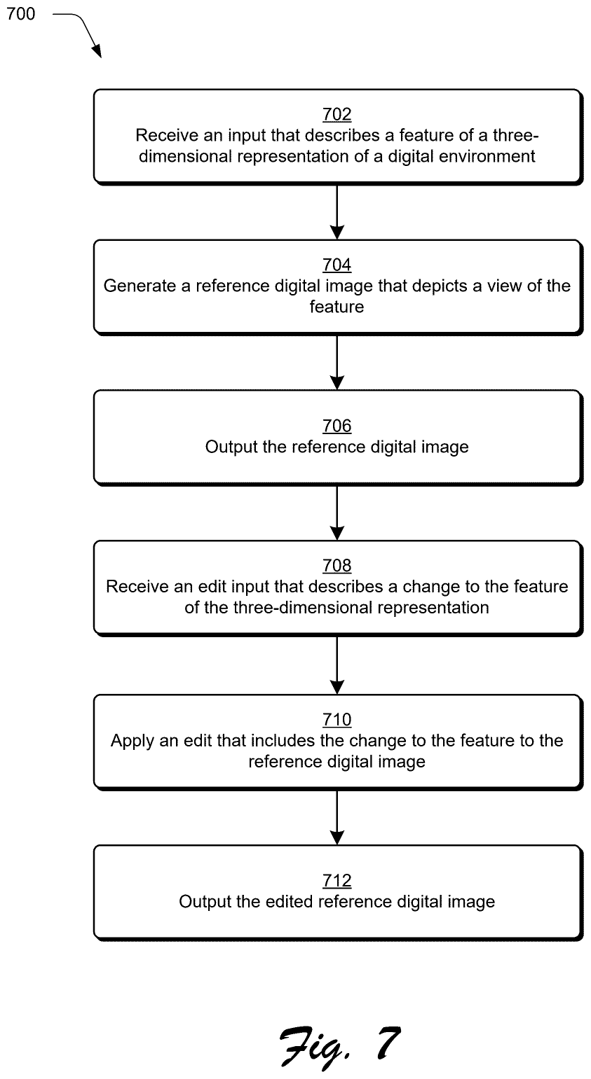

FIG. 7 is a flow diagram depicting an algorithm as a step-by-step procedure 700 in an example implementation that is performable by a processing device to generate a reference digital image and to apply one or more edits to the reference digital image.

To being in this example, an input is received that describes a feature of a three-dimensional representation of a digital environment (block 702). The three-dimensional representation, for instance, is a digital model 124 that includes one or more digital objects, scene elements, lighting conditions, backgrounds, textures, materials, environment settings, simulations, animations, etc. The input 120 further includes a text input 122, such as a text string that describes one or more visual and/or non-visual features of the three-dimensional representation.

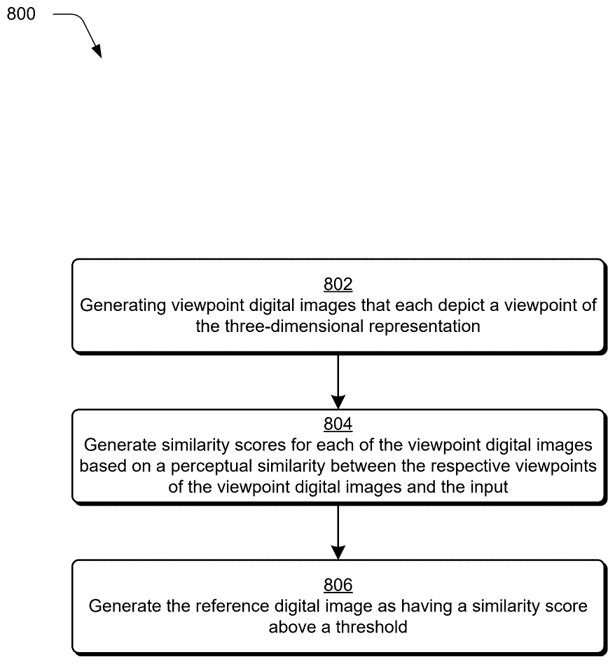

A reference digital image is generated that depicts a view of the feature (block 704). The view of the reference image 118, for instance, is based on a perceptual similarity between the reference digital image and semantic properties of the text input 122. The semantic properties include one or more properties of the text input 122 such as presence/absence of keywords or text strings, relationships between different elements of the text-based input, visual descriptors, a language style of the text-based input, sentiment analysis information, task classification information, etc. In various examples, the generation module 116 leverages a CLIP model 208 to generate the reference image 118, such as further described below with respect to FIG. 8.

The reference digital image is then output (block 706). For instance, the computing device 102 causes the reference image 118 to be presented in a user interface 110 of a display device 112. The view of the reference image 118 represents a desirable view of the feature to align with human perceptual tendencies and to provide a clear visual perspective of the feature. For instance, the view depicts the feature from an orientation that is intuitively understood by the human eye.

In some examples, the generation module 116 receives an input to select the reference image 118. Responsive to the input, the generation module 116 automatically navigates the three-dimensional representation (e.g., a digital model 124 displayed by a three-dimensional modelling application in the user interface 110) to depict a view that replicates the view of the reference image 118. In this way, the techniques described herein are usable to intuitively navigate within a three-dimensional digital environment, which conserves computational resources that would otherwise be consumed to manually navigate within the digital environment to obtain a desired view.

In various examples, an edit input is received that describes a change to the feature of the three-dimensional representation (block 708). The edit input 216, for instance, specifies a change to a feature of the three-dimensional representation of the digital environment, such as the feature depicted by the view of the reference image 118 and/or one or more additional features. In some examples, the generation module 116 receives the edit input 216 supplemental to receipt of the input 120. For instance, the edit input 216 is a separate text-based input received by the generation module 116. Additionally or alternatively, the edit input 216 is included in the input 120. Accordingly, the generation module 116 is configured to extract the edit input 216 from the input 120, such as by leveraging a large language model.

An edit is applied to the reference digital image that includes the change to the feature (block 710). The edit, for instance, is based on one or more of the digital model 124, the text input 122, the view of the reference image 118, and/or the edit input 216. In various examples, the generation module 116 leverages a depth conditioned model 218 to generate an edited reference image 214 based on a text input (e.g., the text input 122 and/or the edit input 216) as well as an underlying geometry of the reference image 118.

The generation module 116, for instance, leverages the depth conditioned model 218 to add and/or to remove one or more features from the reference image 118 to generate the edited reference image 214. In an additional or alternative example, the generation module 116 leverages a stable diffusion inpainting model, e.g., the inpainting model 232, to add and/or remove one or more features to/from the reference image 118 at defined locations to generate the edited reference image 214.

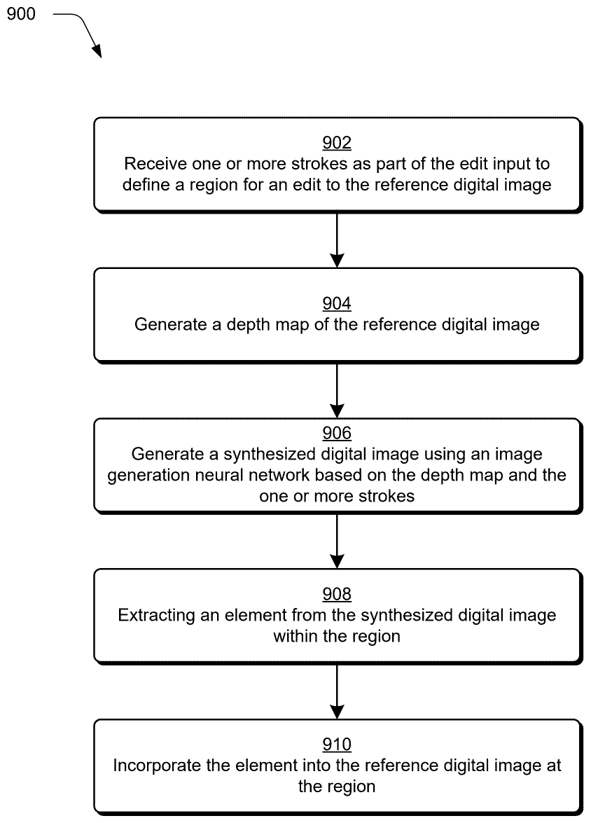

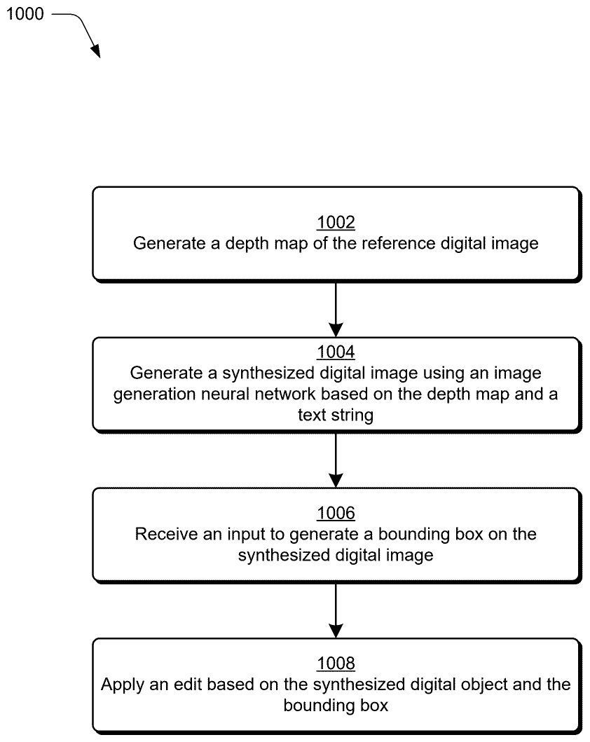

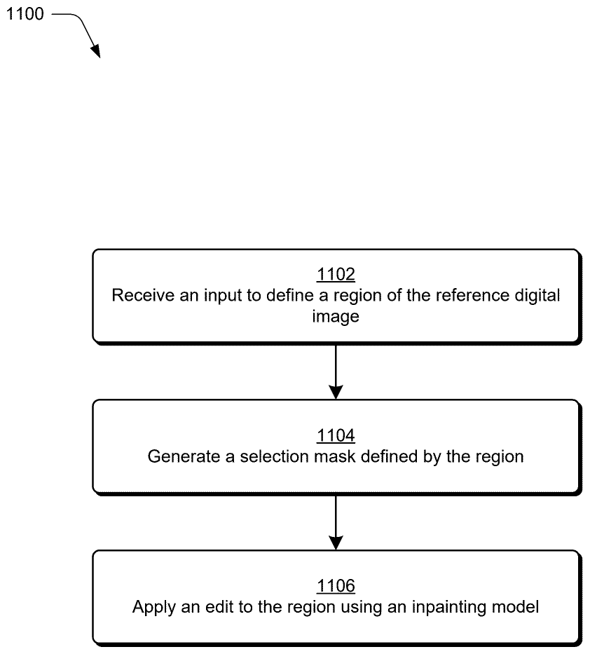

The edited reference digital image is then output (block 712). For instance, the computing device 102 causes the reference image 118 to be output in the user interface 110 of the display device 112. As described in the procedures shown in FIG. 9, FIG. 10, and FIG. 11, a variety of techniques are contemplated to apply the edit to the reference image 118 and accordingly the techniques described herein support a variety of editing operations to the reference image 118 based on user specified inputs, a view of the reference image 118, three-dimensional properties of the digital model 124, and/or various additional edit inputs 216.

FIG. 8 is a flow diagram depicting an algorithm as a step-by-step procedure 800 in an example implementation that is performable by a processing device to generate a reference digital image. One or more steps and/or blocks of the procedure 800, for instance, are implementable as one or more substeps of block 704 of the procedure 700.

To begin in this example, viewpoint digital images are generated that each depict a viewpoint of the three-dimensional representation (block 802). The viewpoint images 204, for instance, have variable perspectives, orientations, and/or zoom conditions relative to the three-dimensional representation.

Similarity scores are then generated for each of the viewpoint digital images (block 804). The similarity scores 206, for instance, are based on a perceptual similarity between respective viewpoints of the viewpoint images 204 and the input, e.g., the text input 122. In some examples, the generation module 116 leverages a CLIP model 208 to generate the similarity scores 206, such as based on a cosine similarity metric.

The reference digital image is generated as having a similarity score above a threshold (block 806). For instance, the generation module 116 selects a viewpoint image 204 with a highest similarity score as the reference image 118. Additionally or alternatively, the generation module 116 selects several viewpoint images 204 as candidate images, such as to be output in the user interface 110 for user selection. In this way, the generation module 116 generates a reference image 118 that includes a view that aligns with human perceptual tendencies to provide a desirable rendering of a particular feature.

FIG. 9 is a flow diagram depicting an algorithm as a step-by-step procedure 900 in an example implementation that is performable by a processing device to apply one or more edits to a reference digital image based on one or more strokes. One or more steps and/or blocks of the procedure 900, for instance, are implementable as one or more substeps of block 710 of the procedure 700.

To being in this example, one or more strokes are received as part of the edit input to define a region for an edit to the reference digital image (block 902). The edit input 216 further includes a text-based input, such as a text string that specifies a change to the feature of the three-dimensional representation. The one or more strokes, for instance, define one or more of a shape, size, spatial location, and/or orientation for the edit to apply the change.

A depth map of the reference digital image is then generated (block 904). The depth map, for instance, is a representation that encodes a distance of objects and/or surfaces in the reference image 118. Each pixel in the depth map, for instance, corresponds to a point in the reference image 118 and indicates a relative depth of the respective point from a virtual camera that defines a view for the reference image 118.

A synthesized digital image is then generated based on the depth map and the one or more strokes (block 906). Generally, the synthesized digital image includes an underlying geometry of the reference image 118 however includes visual variation from the reference image 118 that is based on the text input 122 and/or the edit input 216. The synthesized digital image, for instance, is generated using an image generation neural network, such as a depth conditioned model 218. For instance, the depth conditioned model 218 receives as input an embedding of the text prompt, an embedding of the one or more strokes, and the depth map to generate the synthesized digital image.

An element of the synthesized digital image is extracted from within the region (block 908). The element, for instance, has a visual appearance based on the text-based input and a shape determined by the one or more strokes. The element is incorporated into the reference digital image at the region to generate the edited reference image (block 910). Accordingly, the edited reference image 214 includes the element as specified by the text input 122 and shaped by the one or more strokes within the scene depicted by the reference image 118.

FIG. 10 is a flow diagram depicting an algorithm as a step-by-step procedure 1000 in an example implementation that is performable by a processing device to apply one or more edits to a reference digital image based on one or more bounding boxes applied to define a region for the edit. One or more steps and/or blocks of the procedure 1000, for instance, are implementable as one or more substeps of block 710 of the procedure 700.

To being in this example, a depth map of the reference digital image is generated (block 1002). As in the above example, the depth map is a representation that encodes a distance of objects and/or surfaces in the reference image 118. Each pixel in the depth map, for instance, corresponds to a point in the reference image 118 and indicates a relative depth of the respective point from a virtual camera that defines a view for the reference image 118.

A synthesized digital image is then generated based on the depth map and a text string (block 1004). The text string, for instance, describes a change to a feature of the three-dimensional representation and is received as part of the text input 122 and/or the edit input 216. The synthesized digital image 228 includes an underlying geometry of the reference image 118 however includes visual variation from the reference image 118 that is based on the text input 122 and/or the edit input 216. The synthesized digital image 228, for instance, is generated using an image generation neural network, such as a depth conditioned model 218. For instance, the depth conditioned model 218 receives as input an embedding of the text string and the depth map to generate the synthesized digital image 228.

An input is then received to generate a bounding box on the synthesized digital image (block 1006). The bounding box, for instance, indicates one or more regions to incorporate to the edited reference image 214 and/or regions to exclude from the edited reference image 214.

An edit is then applied based on the synthesized digital image and the bounding box (block 1008). In one example, the edit includes to incorporate a salient object detected within the bounding box to the edited reference image 214. In an additional or alternative example, the edit includes to incorporate a region outside the bounding box to the edited reference image 214. Accordingly, the techniques described herein support a variety of edits to the reference image 118 based on properties of user inputs and visual properties of the three-dimensional digital environment. This overcomes the limitations of conventional techniques, which are either not based on an underlying geometry of the three-dimensional representation or involve complex three-dimensional editing operations.

FIG. 11 is a flow diagram depicting an algorithm as a step-by-step procedure 1100 in an example implementation that is performable by a processing device to apply one or more edits to a reference digital image using an inpainting model. One or more steps and/or blocks of the procedure 1100, for instance, are implementable as one or more substeps of block 710 of the procedure 700.

To start in this example, an input is received to define a region of the reference digital image (block 1102). The input, for instance is an edit input 216 that includes a text string that specifies a change to a feature of the reference image 118 and a user input to draw a region on the reference image 118 such as via one or more strokes, a user action to “paint” on the reference image 118, etc.

The generation module 116 then generates a selection mask defined by the region (block 1104). The selection mask, for instance, identifies the region specified by the user input and configures the region as an editable region. An edit is then applied to the region using an inpainting model (block 1106). The edit, for instance, includes the change specified by the text string at a location specified by the user input, e.g., the one or more strokes. In various examples, the inpainting model is a stable diffusion inpainting model. In this way, a user is able to efficiently make local visual changes to the reference image 118 without altering a global appearance of the reference image 118.

### Example System and Device

FIG. 12 illustrates an example system generally at 1200 that includes an example computing device 1202 that is representative of one or more computing systems and/or devices that implement the various techniques described herein. This is illustrated through inclusion of the generation module 116. The computing device 1202 is configurable, for example, as a server of a service provider, a device associated with a client (e.g., a client device), an on-chip system, and/or any other suitable computing device or computing system.

The example computing device 1202 as illustrated includes a processing system 1204, one or more computer-readable media 1206, and one or more I/O interface 1208 that are communicatively coupled, one to another. Although not shown, the computing device 1202 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1204 is representative of functionality to perform one or more operations using hardware. Accordingly, the processing system 1204 is illustrated as including hardware element 1210 that is configurable as processors, functional blocks, and so forth. This includes implementation in hardware as an application specific integrated circuit or other logic device formed using one or more semiconductors. The hardware elements 1210 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1206 is illustrated as including memory/storage 1212. The memory/storage 1212 represents memory/storage capacity associated with one or more computer-readable media. The memory/storage 1212 includes volatile media (such as random access memory (RAM)) and/or nonvolatile media (such as read only memory (ROM), Flash memory, optical disks, magnetic disks, and so forth). The memory/storage 1212 includes fixed media (e.g., RAM, ROM, a fixed hard drive, and so on) as well as removable media (e.g., Flash memory, a removable hard drive, an optical disc, and so forth). The computer-readable media 1206 is configurable in a variety of other ways as further described below.

Input/output interface(s) 1208 are representative of functionality to allow a user to enter commands and information to computing device 1202, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1202 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1202. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1202, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1210 and computer-readable media 1206 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employed to implement various techniques described herein. Accordingly, software, hardware, or executable modules are implemented as one or more instructions and/or logic embodied on some form of computer-readable storage media and/or by one or more hardware elements 1210. The computing device 1202 is configured to implement particular instructions and/or functions corresponding to the software and/or hardware modules. Accordingly, implementation of a module that is executable by the computing device 1202 as software is achieved at least partially in hardware, e.g., through use of computer-readable storage media and/or hardware elements 1210 of the processing system 1204. The instructions and/or functions are executable/operable by one or more articles of manufacture (for example, one or more computing devices 1202 and/or processing systems 1204) to implement techniques, modules, and examples described herein.

The techniques described herein are supported by various configurations of the computing device 1202 and are not limited to the specific examples of the techniques described herein. This functionality is also implementable all or in part through use of a distributed system, such as over a “cloud” 1214 via a platform 1216 as described below.

The cloud 1214 includes and/or is representative of a platform 1216 for resources 1218. The platform 1216 abstracts underlying functionality of hardware (e.g., servers) and software resources of the cloud 1214. The resources 1218 include applications and/or data that can be utilized while computer processing is executed on servers that are remote from the computing device 1202. Resources 1218 can also include services provided over the Internet and/or through a subscriber network, such as a cellular or Wi-Fi network.

The platform 1216 abstracts resources and functions to connect the computing device 1202 with other computing devices. The platform 1216 also serves to abstract scaling of resources to provide a corresponding level of scale to encountered demand for the resources 1218 that are implemented via the platform 1216. Accordingly, in an interconnected device embodiment, implementation of functionality described herein is distributable throughout the system 1200. For example, the functionality is implementable in part on the computing device 1202 as well as via the platform 1216 that abstracts the functionality of the cloud 1214.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, in a user interface of a processing device that includes a three-dimensional representation of a digital environment, a text-based input that describes a feature of the three-dimensional representation;
generating, by the processing device, a reference digital image that depicts a view of the feature based on a perceptual similarity between the reference digital image and semantic properties of the text-based input; and
outputting, in the user interface of the processing device, the reference digital image.

2. The method as described in claim 1, wherein the generating the reference digital image includes:
generating, by the processing device, a plurality of digital images that each depict a viewpoint of the three-dimensional representation;
generating, by the processing device, similarity scores for each of the plurality of digital images based on a perceptual similarity between the respective viewpoints of the plurality of digital images and the text-based input; and
generating, by the processing device, the reference digital image as having a similarity score above a threshold.

3. The method as described in claim 2, wherein each of the respective viewpoints of the plurality of digital images is defined by a three-dimensional position, a distance to a virtual camera, a longitudinal rotation, and a latitudinal rotation.

4. The method as described in claim 2, wherein the similarity scores are based on a cosine similarity between the respective viewpoints of the plurality of digital images and the text-based input.

5. The method as described in claim 2, wherein the similarity scores are generated using a contrastive language-image pretraining model.

6. The method as described in claim 2, further comprising outputting two or more candidate digital images that have similarity scores above the threshold, and the generating the reference digital image includes receiving an input to select a candidate digital image from the two or more candidate digital images.

7. The method as described in claim 1, further comprising navigating, automatically and responsive to an input to select the reference digital image in the user interface, the three-dimensional representation to replicate the view of the reference digital image.

8. The method as described in claim 1, wherein the feature is a three-dimensional digital object located within the digital environment.

9. The method as described in claim 1, wherein the feature includes one or more of a lighting condition or an environmental feature of the three-dimensional representation of the digital environment.

10. A system comprising:
a memory component; and
a processing device coupled to the memory component, the processing device to perform operations including:
receiving, in a user interface of the processing device, a user input that includes a text string that describes a change to a feature of a three-dimensional representation of a digital environment displayed by the user interface;
generating a reference digital image that depicts a view of the feature based on a perceptual similarity between one or more viewpoint digital images and semantic properties of the user input; and
applying an edit that includes the change to the feature to the reference digital image based on the text string and the view.

11. The system as described in claim 10, wherein the generating the reference digital image includes:
generating the one or more viewpoint digital images that each depict a viewpoint of the three-dimensional representation;
generating similarity scores for each of the one or more viewpoint digital images based on a perceptual similarity between the respective viewpoints of the one or more viewpoint digital images and the text string; and
generating the reference digital image as a viewpoint digital image with a highest similarity score.

12. The system as described in claim 10, wherein the user input further includes one or more strokes to the reference digital image, the operations further including defining a region for the edit based on the one or more strokes.

13. The system as described in claim 12, the applying the edit including:
generating a depth map of the reference digital image;
generating a synthesized digital image using a depth conditioned image generation neural network based on the depth map, the one or more strokes, and the text string;
extracting an element from the synthesized digital image within the region; and
incorporating the element into the reference digital image using a zero-shot image segmentation model.

14. The system as described in claim 12, the defining the region for the edit including using a holistically-nested edge detection model to identify the region based on the one or more strokes.

15. The system as described in claim 10, the applying the edit including:
generating a depth map of the reference digital image;
generating a synthesized digital image using a depth conditioned image generation neural network based on the depth map and the text string;
receiving an input to generate a bounding box on the synthesized digital image; and
applying the edit further based on the synthesized digital image and the bounding box.

16. The system as described in claim 10, wherein the user input further includes an action to define a region of the reference digital image, the applying the edit including generating a selection mask defined by the region and using a stable diffusion inpainting model to apply the edit to the region based on the text string, the view, and the selection mask.

17. A non-transitory computer-readable storage medium storing executable instructions, which when executed by a processing device, cause the processing device to perform operations comprising:
receiving, in a user interface of the processing device that includes a three-dimensional representation of a digital environment, a user input that describes a feature of the three-dimensional representation;
generating a reference digital image that depicts a view of the feature based on a perceptual similarity between the reference digital image and semantic properties of the user input; and
presenting the reference digital image in the user interface.

18. The non-transitory computer-readable storage medium as described in claim 17, wherein the generating the reference digital image includes:
generating a plurality of digital images that each depict a viewpoint of the three-dimensional representation;
generating similarity scores for each of the plurality of digital images based on a perceptual similarity between the respective viewpoints of the plurality of digital images and the user input; and
generating the reference digital image as having a similarity score above a threshold.

19. The non-transitory computer-readable storage medium as described in claim 17, the operations further comprising applying one or more edits to the reference digital image based on the user input and the view.

20. The non-transitory computer-readable storage medium as described in claim 17, the operations further comprising navigating, automatically and responsive to an input to select the reference digital image in the user interface, the three-dimensional representation to replicate the view of the reference digital image.
